(19) United States
(12) Patent Application Publication
(10) Pub. No.: US 2002/0126203 A1
(43) Pub. Date: Sep. 12, 2002

(54) Method for generating synthetic key frame based upon video text

(75) Inventors: Jae Shin Yu, Seoul (KR); Sung Bae Jun, Seoul (KR); Kyoung Ro Yoon, Seoul (KR)

Correspondence Address: FLESHNER & KIM, LLP, P.O. Box 221200, Chantilly, VA, 20153-1200, US

(73) Assignee: LG Electronics, Inc.

(21) Appl. No.: 10/091,472

(22) Filed: Mar. 7, 2002

(30) Foreign Application Priority Data
Mar. 9, 2001 (KR) 12184/2001

(51) Int. Cl. H04N 7/18

(52) U.S. Cl. 348/61

(57) ABSTRACT

The present invention generally relates to a multimedia browsing system, and more particularly, to a method for generating a synthetic key frame, which allows a video stream to be efficiently summarized while being searched and filtered based upon the summarization. The present invention generates the synthetic key frame based upon video text by calculating an importance measure of text areas extracted from the video image and using only those text areas having the importance measures of at least a predetermined value.

### BACKGROUND OF THE INVENTION

1. Field of the invention

The present invention generally relates to a multimedia browsing system, and more particularly, to a method for generating a synthetic key frame, which allows a video to be efficiently summarized while being searched and filtered based upon the summarization.

2. Description of the prior art

Development of digital video and image/video/audio recognition techniques allows users to search/filter and browse desired portions of a video at a desired time point.

The most basic technique for a non-linear video content browsing and searching is a shot segmentation scheme and a shot clustering scheme, both of which are the most critical for structurally analyzing multimedia contents.

FIG. 1 illustrates an example of structural information of a video stream.

Referring to FIG. 1, structural information exists in the video stream, which has a temporal continuity. In general, the video stream has a hierarchical structure regardless of genres. The video stream is divided into several scenes as logical units, in which each of the scenes is composed of a number of sub-scenes or shots. The sub-scene itself is a scene, and thus it has attributes of the scene as it is. In the video stream, the shots mean a sequence of video frames taken by one camera without interruption.

Most multimedia indexing systems extract the shots from the video stream and detect the scenes as the logical units using other information based upon the extracted shots to index structural information of the multimedia stream.

As described above, the shots are the most basic units for analyzing or constructing the video. In general, the scene is a meaningful component existing in the video stream as well as a meaningful discriminating element in story development or construction of the video stream. One scene may include several shots in general.

Conventional video indexing techniques structurally analyze the video stream to detect the shots and scenes as unit segments and extract key frames based upon the shots and scenes. The key frames represent the shots and scenes, and those key frames are utilized as a material for summarizing the video or used as means for moving to desired positions.

As set forth above, various researches are in progress for extracting a principal text area, a news icon, a human face area and the like that express meaningful information in the video stream for efficient video searching and browsing. Methods have been introduced for synthesizing such key areas to generate new key frames. A synthetic key frame is a technique for synthesizing contents of the video stream in logical or physical units by using the key areas extracted from the scene or shot units. Using the synthetic key frame, a great amount of information can be expressed in a small display space. A user can readily understand specific portions of the contents and selectively watch specific portions the user wants.

An application utilizing the synthetic key frame of the video text can be readily operated in all systems having a browsing interface for video searching and summarization of a specific range of the video stream.

Most of video indexing systems extract key frames to represent the scenes and shots as the structural components of the video stream, and use the same for the purpose of searching or browsing. In order to efficiently carry out the foregoing process, a method of generating a synthetic key frame is presented.

FIG. 2 shows a concept of synthetic key frame generation.

Referring to FIG. 2, key frames are detected from scenes as logical units or shots as physical units in a video stream, and then the detected key frames are logically or physically synthesized to provide a user with synthesized key frames. Using the synthetic key frames, the user readily understands video contents and rapidly accesses to desired positions.

Meanwhile, principal text areas expressing meaningful information in the video stream can be extracted for efficient video searching and browsing. This technique extracts a minimum block range (MBR) of the text displayed in a video image to provide a function for allowing the user to readily understand and index the contents of the video. Also, remote information searching can be executed on a network based upon flexible information searching and indexed information. Describing a method of extracting text in detail, candidate areas are primarily extracted based upon a property that horizontal and vertical edge histograms are concentrically appeared and information that the edge histogram is repeatedly varied in size as spaces of characters are varied. From the candidate areas, an area is extracted as a text area, which has an aspect ratio satisfying that of a text, a small amount of motion and a color with brightness highly different from that of the background.

As described before, the conventional technique about the synthetic key frame synthesizes a certain interval of the video contents into one key frame using the key area or key text, and uses this key frame as means representing the corresponding interval.

Among them, the video text generally has a characteristic that summarizes the total contents or a portion thereof, and thus it functions as very important means for providing summarized information about the contents to the user.

However, there has been so far no solid proposal to the method of generating a text or text-based synthetic key frame, i.e. the text-based synthetic key frame is generated arbitrarily or without consideration of an importance measure for each of the extracted text areas. Therefore, when the synthetic key frame according to such a method is used to summarize the contents, important information tend to be practically excluded from the synthetic key frame. As a result, in generation of the text-based synthetic key frame for transferring a large amount of information in a restricted space, it is critical to judge which text area is practically important text area and to consider how to synthesize the text area.

### SUMMARY OF THE INVENTION

Accordingly, the present invention is directed to a method for generating a synthetic key frame based upon video text that substantially obviates one or more problems due to limitations and disadvantages of the related art.

It is an object of the invention to provide a method for generating a synthetic key frame based upon video text, which enables efficient summarization and searching therefore.

To achieve above object and other advantages and in accordance with the purpose of the invention, as embodied and broadly described herein, there is provided a method for generating a synthetic key frame based upon video text by calculating an importance measure of text areas each extracted from the video image and using only those text areas having the importance measure of at least a predetermined value.

It is another object of the invention to provide an importance calculating method for synthesizing a key frame.

According to an aspect of the invention to achieve the foregoing objects, a method of generating a synthetic key frame of video text comprises the following steps of: extracting a plurality of text areas from a video stream; calculating importance measures according to weights for each of the extracted text areas; selecting the number of text areas to be synthesized based upon the importance measures in the order of higher importance; and synthesizing the text areas to be synthesized into the key frame.

In the method of generating a synthetic key frame of video text, the text areas are extracted according to certain intervals of the video stream, and the synthetic key frame is generated in each of the certain intervals of the video stream.

In the method of generating a synthetic key frame of video text, the weight is determined in proportion to the size of the text area, the mean text size of the text area and the display duration time of a text.

In the method of generating a synthetic key frame of video text, the weight increases as the size of the text area increases, the mean text size in the text area increases, or the display duration time of the text increases.

In the method of generating a synthetic key frame of video text, the number of the text areas to be synthesized is selected from the plurality of text areas in the order of importance measure.

According to another aspect of the invention to achieve the foregoing objects, a method of generating a synthetic key frame of video text comprises the following steps of: determining weights of a plurality of text areas based upon weight determining factors; calculating importance measures of the text areas by applying the weights according to a certain rule; selecting the number of text areas to be synthesized based upon the importance measures in the order of higher importance; and synthesizing the text areas to be synthesized into the key frame.

In the method of generating a synthetic key frame of video text, each of the weight determining factors includes the size of the text areas, mean text size in the text area and the display duration time of a text.

In the method of generating a synthetic key frame of video text, the certain rule is addition of values obtained by multiplying the weight determining factors each with the corresponding weights each.

According to still another aspect of the invention to achieve the foregoing objects, a method of calculating importance measure for generating a synthetic key frame, the method comprising the following steps of: determining the sizes of weight determining factors based upon one text area of a plurality of text areas; determining weights based upon the sizes of the weight determining factors; and adding values obtained by multiplying the sizes of the weight determining factors with corresponding weights.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore not to be considered limiting of its scope, the invention will be described with additional specificity and detail through use of the accompanying drawings in which:

FIG. 1 illustrates an example of structural information of a video stream;

FIG. 2 illustrates a concept of generating a synthetic key frame of the related art;

FIG. 3 is a flow chart illustrating a method of generating a synthetic key frame of the invention;

FIG. 4 illustrates a concept of generating a synthetic key frame based upon video text of the invention;

FIG. 5 illustrates a method of generating a synthetic key frame based upon video text of the invention;

FIG. 6 illustrates a method of generating a synthetic key frame based upon video text of the invention;

FIG. 7 illustrates a method of anticipating the mean text size in a text area of the invention; and

FIG. 8 illustrates a video browsing interface using a synthetic key frame of the invention.

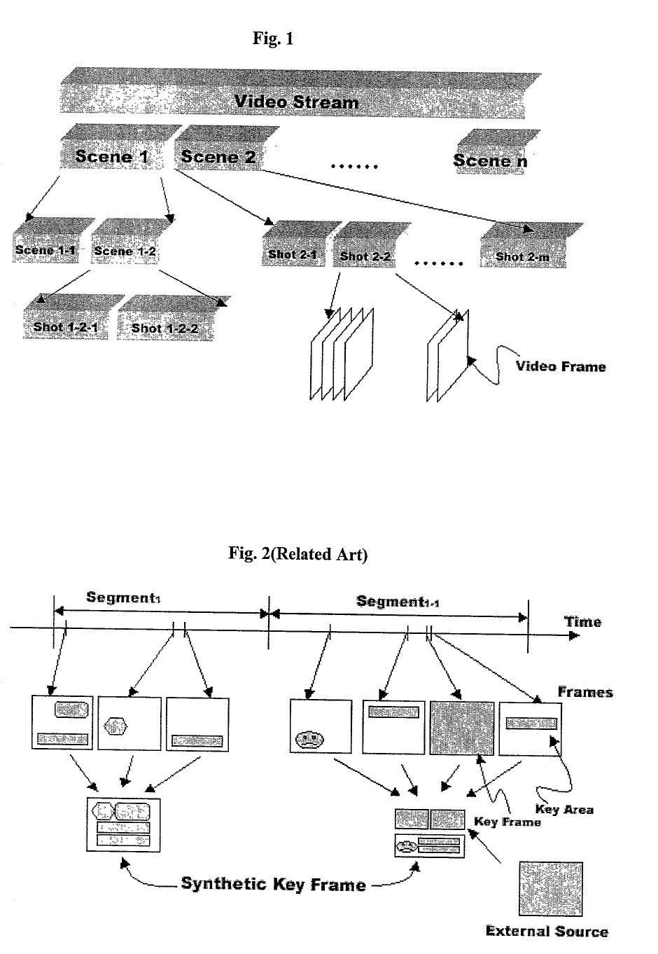

### DETAILED DESCRIPTION OF THE INVENTION

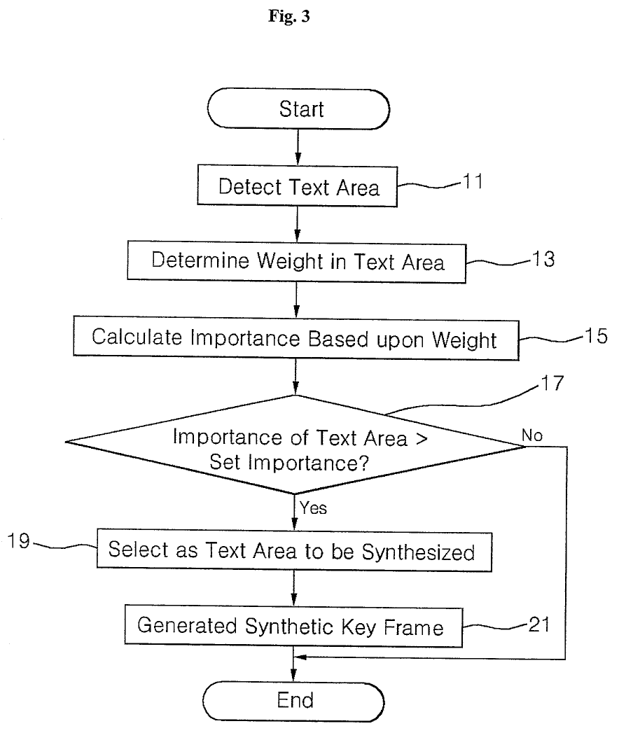

The following detailed description of the embodiment of the present invention, as represented in FIGS. 3-8, is not intended to limit the scope of the invention, as claimed, but is merely representative of the presently preferred embodiments of the invention. In the description, same drawing reference numerals are used for the same elements even in different drawings. The matters defined in the description are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

FIG. 3 is a flow chart illustrating a method of generating a synthetic key frame of the invention.

First, FIG. 3 illustrates a synthetic key frame, which is generated from one shot or scene unit. However, a video stream has a plurality of shots or scenes as described before. The present invention divides a text area extracted from the video stream in the unit of a shot or scene, and generates the synthetic key frame with the text area extracted in the unit of a shot or scene. Therefore, the shot or scene can be designated as one interval, and one synthetic key frame can be generated in each interval. In this case, an importance measure can be applied for generating a more meaningful synthetic key frame. Therefore, applying the description of FIG. 3, it is noted that a plurality of synthetic key frame can be generated from the video stream.

As shown in FIG. 3, a text area is extracted according to a predetermined interval from a video stream as described above (step 11).

The text area is extracted as follows: Candidate areas are extracted based upon a property that horizontal and vertical edge histograms are concentrically appeared and information that the edge histogram is repeatedly varied in size according to a space of the character. Among the candidate areas, an area is extracted as a text area, which has an aspect ratio satisfying that of a text, a small amount of motion and a color with brightness highly different from that of the background.

When the text area is extracted, a weight is determined to the extracted text area (step 13). The weight is determined by using weight determining factors, which may include the size of the text area, the mean text size in the text area, the display duration time of a text and the like. Therefore, the weight can be determined in proportion to the size of the text area, the mean text size in the text area and the display duration tine of the text. In other words, as the size of the text area or the mean text size in the text area increases, the weight can increase also. In the same manner, as the display duration time increases, the weight can increase. Of course, when each weight determining factor decreases or reduces, the weight can proportionally decrease.

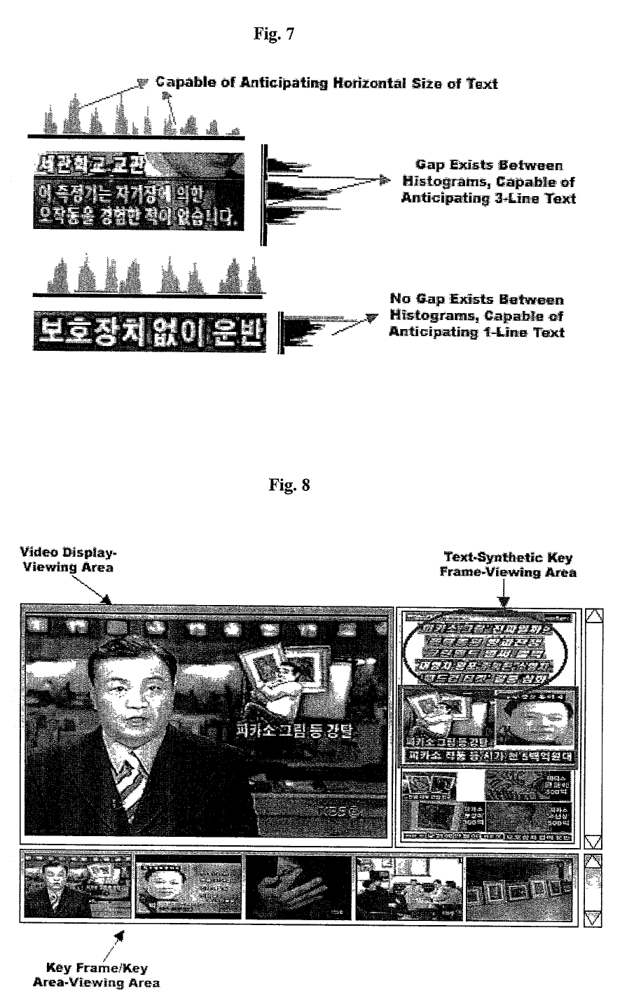

The mean text size in the text area can be determined by densities and sizes of histograms as shown in FIG. 7. If the size of the text is small, the size of a horizontal edge histogram is decreased between each line, and the size of a vertical edge histogram is also decreased between each line. On the contrary, if the size of the text is large, the horizontal edge histogram is widely distributed without a phenomenon that the size of the histogram is abruptly decreased in the middle. The mean text size in the text area can be determined based upon information about the densities and sizes of the histograms as set forth above.

The duration time of the text can be obtained by comparing a previously extracted text area with a currently extracted text area. If the size and position of the extracted text areas have similar and the difference between edge histogram values of the text areas is smaller than a predetermined threshold valve, the currently extracted text area is judged as the same as the previously extracted text area. Then, the duration time of the extracted text can be extended.

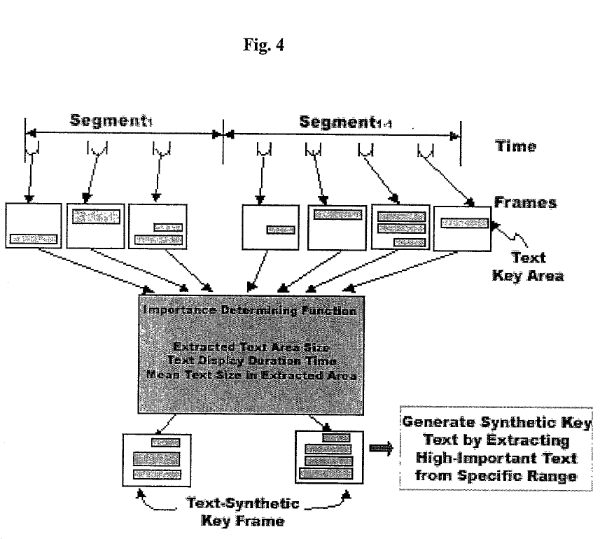

As shown in FIG. 4, a synthetic key frame can be generated by synthesizing only a preferred text area among the text areas extracted from the video stream with the key frame according to an importance measure satisfying an importance function (refer to Equation 1).

The weights allocated according to the weight determining factors are applied to Equation 1 to calculate the importance (I) of the text area (step 15).

I=A*a+B*b+C*c . . . Equation 1,

wherein a+b+c=1, A is the size of the text area, B is the mean size in the text area, C is the display duration time of the text. Each of a, b and c means the weight for each weight determining factor.

Therefore, the importance can be determined as the sum of values obtained by multiplying the weight determining factors with the corresponding weights respectively.

Meanwhile, the importance of the text area is compared with a pre-set importance (step 17). The pre-set importance can be set according to the size of a device to be displayed or the size of the synthetic key frame area in a browser. If the size of the browser increases, the size of the synthetic key frame can be increased. Accordingly, the number or size of the text areas to be synthesized can be increased and the importance measure can be also increased. If the number or size of the key frame to be synthesized is changed, the readability of the user can be considered.

If the importance of the text area is larger than a pre-set importance as a result of comparison, the text area is selected as the text area to be synthesized (step 19).

The foregoing steps 11 to 19 are performed to the text areas extracted in the shot or scene units. At least one text area to be synthesized is selected in step 19.

The at least one text area selected to be synthesized in step 19 is synthesized into the key frame (step 21).

As a result, the synthetic key frame generated in step 21 is generated for the text areas extracted from one shot or scene, so that the steps 11 to 21 are repeatedly performed to generate one synthetic key frame per one shot or scene included in the video stream.

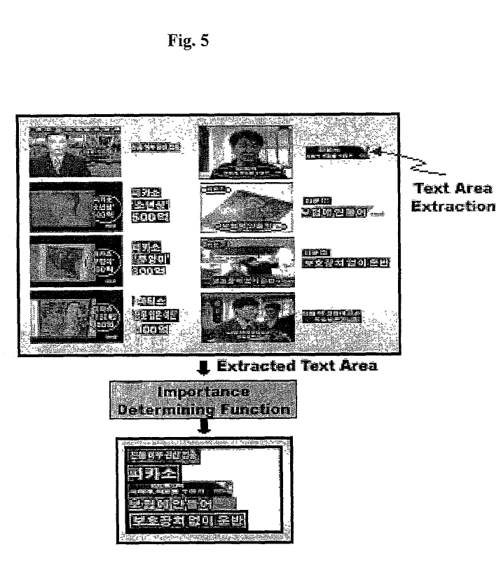

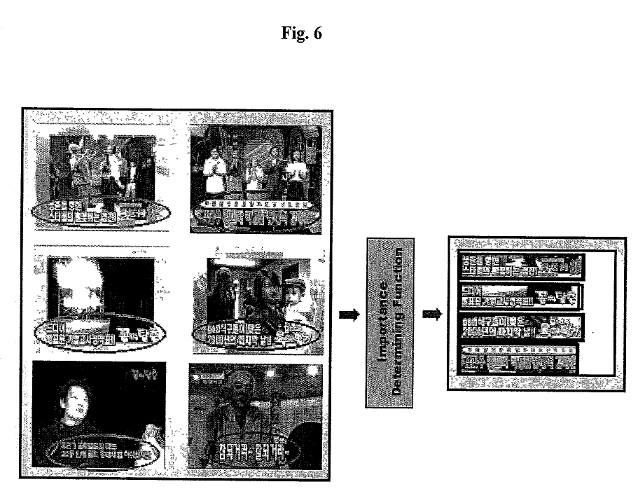

FIGS. 5 and 6 illustrate a method of generating a synthetic key frame of a video stream according to the invention, in which FIG. 5 illustrates a method of generating a synthetic key frame based upon video text about a specific article interval in a news video, and FIG. 6 illustrates a method of generating a synthetic key frame based upon video text in a show program.

As shown in FIGS. 5 and 6, the importances are respectively calculated about the text areas in specific ranges and the text areas are synthesized into the key frames in the order of importance considering the sizes of browser areas to be displayed so as to generate the synthetic key frames.

Referring to FIG. 5, news video contents can be comprehensively expressed as follows: All text areas in a specific interval, e.g. shots or scenes corresponding to a specific article are extracted from the new video contents. Weights to the extracted texts are determined in proportion to the sizes of the extracted text areas, the means text sizes in the text areas and the duration times of the text areas. Importance measures of the text areas are calculated based upon the determined weights. The number or size of the texts to be synthesized is determined in the order of higher importance corresponding to the size of browser or display. The determined numbers of text areas or text areas having determined sizes are synthesized into one key frame to generate a synthetic key frame.

Referring to FIG. 6, show video contents can be represented as follows: Text areas in a specific interval are extracted from the show video contents. A predetermined number of text areas or text areas having predetermined sizes are selected considering importance, browser size and the like as shown in FIG. 5. The selected text areas are synthesized into one key frame.

Applications related to the invention may include the Universal Multimedia Access (UMA) Applications. In general, user available data are restricted by a user terminal or a network environment connecting between user terminals and a server, i.e. multimedia moving image display is not supported while a still image is supported or an audio is supported while an image is not supported based upon which device is used. Further, the quantity of data to be transmitted in a given time can be restricted because transmission capacity is insufficient according to a network connection scheme or medium. In adaptation to various user environmental variations like this, multimedia data need to be processed into an optimized form of user environment in order to promote the convenience of the user and improve the ability of information transfer. All applications for embodying such a purpose are called the UMA applications.

For example, if the video stream cannot be displayed due to constraints such as the device and network, the video stream is transmitted as converted into the reduced size and number of text key frame to promote the minimum understanding of the user about corresponding video contents as long as the user environment permits. Therefore, the text-based synthetic key frame of the invention is applied to the UMA applications to be used as means for providing large amount of meaningful information while reducing the number of the key frames and the quantity of the data to. be transmitted.

Another example of applications related to the invention may include a non-linear video browsing application (refer to FIG. 8). If the entire video stream is not summarized, the user has to watch the entire video in order to understand the video stream. Even if the user wants to move to a target position, a large amount of time is required to get the position because the user has to seek by him/herself up to a target position in the video stream. In order to rapidly search and access the video stream, the non-linear browsing is used. Key frames extracted from the entire video contents are summarized in specific units to be provided to the user. The user can search the video stream from a desired position.

According to the invention, as shown in FIG. 8, a browser includes a video display-viewing area, a key frame/key area-viewing area and a text key frame-viewing area. In particular, a text of higher importance area is synthesized via the text key frame-viewing area. Then, the user readily understands principal contents in a medium such as a news or show program.

As described above, the present invention applies the importance measures to the extracted text areas and synthesizes the text areas into the key frame in the order of higher importance, for summarizing the video contents more apparently and improving the understanding of the user.

The synthetic key frame of the video text generated according to the invention can be applied to the UMA applications and the non-linear video browsing application.

While the invention has been described in conjunction with various embodiments, they are illustrative only. Accordingly, many alternative, modifications and variations will be apparent to persons skilled in the art in light of the foregoing detailed description. The foregoing description is intended to embrace all such alternatives and variations falling with the spirit and broad scope of the appended claims.

What is claimed is:

1. A method of generating a synthetic key frame of video text, the method comprising the steps of:
extracting a plurality of text areas from a video stream;
calculating importance measures according to weights for each of the extracted text areas;
selecting the number of text areas to be synthesized based upon the importance measures in the order of higher importance; and
synthesizing the text areas to be synthesized into the key frame.

2. The method of generating a synthetic key frame of video text according to claim 1, wherein the text areas are extracted according to certain intervals of the video stream.

3. The method of generating a synthetic key frame of video text according to claim 2, wherein the synthetic key frame is generated in each of the certain intervals of the video stream.

4. The method of generating a synthetic key frame of video text according to claim 2, wherein the certain intervals of the video stream are discriminated by scenes as logical edition units of a video.

5. The method of generating a synthetic key frame of video text according to claim 2, wherein the certain intervals of the video stream are discriminated by shots as physical edition units of a video.

6. The method of generating a synthetic key frame of video text according to claim 1, wherein the weights are determined in proportion to the size of the text area, the mean text size of the text area and the display duration time of a text.

7. The method of generating a synthetic key frame of video text according to claim 6, wherein the mean text size in the text area is determined by using the density and size of a histogram for the text area.

8. The method of generating a synthetic key frame of video text according to claim 6, wherein the display duration time of the text is determined by considering whether a previously extracted text area is identical to a currently extracted text area.

9. The method of generating a synthetic key frame of video text according to claim 6, wherein the weight increases as the size of the text area, the mean text size in the text area or the display duration time of the text increases.

10. The method of generating a synthetic key frame of video text according to claim 1, wherein the number of the text areas to be synthesized is selected from the plurality of text areas in the order of importance.

11. The method of generating a synthetic key frame of video text according to claim 10, wherein the number the text areas to be synthesized is determined according to browser size.

12. The method of generating a synthetic key frame of video text according to claim 10, wherein the sizes of the text areas to be synthesized are determined according to browser size.

13. A method of generating a synthetic key frame of video text, the method comprising the following steps of:
determining weights for a plurality of text areas based upon weight determining factors;
calculating importance measures of the text areas by applying the weights according to a certain rule;
selecting the number of text areas to be synthesized based upon the importance measures in the order of higher importance; and
synthesizing the text areas to be synthesized into the key frame.

14. The method of generating a synthetic key frame of video text according to claim 13, wherein the weight determining factors includes the size of the text areas, mean text size in the text area and the display duration time of a text.

15. The method of generating a synthetic key frame of video text according to claim 13, wherein the certain rule is addition of values obtained by multiplying the weight determining factors with the corresponding weights.

16. The method of generating a synthetic key frame of video text according to claim 13, wherein the number of the text areas to be synthesized is selected from the plurality of text areas in the order of importance.

17. A method of calculating importance measure for generating a synthetic key frame, the method comprising the steps of:
determining the sizes of weight determining factors;
determining weights based upon the sizes of the weight determining factors; and
adding values obtained by multiplying the weight determining factors with corresponding weights.

18. The method of calculating importance measure for generating a synthetic key frame according to claim 17, wherein the weight determining factors include the size of the text areas, mean text size in the text area and the display duration time of a text.

19. The method of calculating importance for key frame synthesis according to claim 18, wherein the mean text size in the text area is determined by the densities and sizes of histograms about the text area.

20. The method of calculating importance for key frame synthesis according to claim 18, wherein the display duration time of the text is determined by considering whether a previously extracted text area is identical to a currently extracted text area.
